(19) United States
(12) Patent Application Publication
(10) Pub. No.: US 2025/0092538 A1
(43) Pub. Date: Mar. 20, 2025

(54) CROSS-FLOW COMPONENT FOR ELECTROCHEMICAL DEVICE

(71) Applicant: HYAXIOM, INC., East Hartford, CT (US)

(72) Inventor: Jesse Marzullo, New Paltz, NY (US)

(21) Appl. No.: 18/470,647

(22) Filed: Sep. 20, 2023

(51) Int. Cl. C25B 11/036; C25B 9/23; H01M 8/0258; H01M 8/10

(52) U.S. Cl. CPC C25B 11/036; C25B 9/23; H01M 8/0258; H01M 2008/1095

(57) ABSTRACT

A bipolar plate for an electrochemical device may include, among other things, a conductive main body extending between first and second sides to define a cross-flow arrangement. The cross-flow arrangement may include first flow channels interspersed with first ribs along the first side, second flow channels interspersed with second ribs along the second side, and cross-over channels that may extend across the respective first ribs to interconnect the adjacent first flow channels. A method of forming a component for an electrochemical device is also disclosed.

### BACKGROUND

This disclosure relates to electrochemical devices including cross-flow arrangements and methods of fabrication and operation.

Electrolyzers are known electrochemical devices that may be configured to convert electricity and water into hydrogen and oxygen. The electrolyzer may include a conductive bipolar plate between an anode and a cathode. Flow paths may be established on opposite sides of the plate. The bipolar plate may be coated. Two separate plates may be stamped and then joined together to form an assembly. Coolant flow paths may be established between the plates to convey liquid coolant through the assembly.

### SUMMARY

A bipolar plate for an electrochemical device may include a conductive main body extending between a first side and a second side to define a cross-flow arrangement. The cross-flow arrangement may include first flow channels interspersed with first ribs along the first side. The first flow channels may be dimensioned to convey a first fluid in a first direction. Second flow channels may be interspersed with second ribs along the second side. The second flow channels may be dimensioned to convey a second fluid substantially in the first direction. The first flow channels may be established in the respective second ribs. The second flow channels may be established in the respective first ribs. Cross-over ribs may extend across a floor of the respective second flow channels to interconnect adjacent second ribs. Cross-over channels may be established in the respective cross-over ribs. The cross-over channels may extend across the respective first ribs to interconnect the adjacent first flow channels. The cross-over channels may be dimensioned to convey the first fluid in a second direction transverse to the first direction.

An assembly may include a first electrochemical cell including a first proton exchange membrane (PEM) between a first anode and a first cathode. A second electrochemical cell may include a second proton exchange membrane between a second anode and a second cathode. A conductive bipolar plate may be between the first anode and the second cathode. The bipolar plate may extend between first and second sides to define a cross-flow arrangement. The cross-flow arrangement may include first flow channels interspersed with first ribs along the first side. The first flow channels may be dimensioned to convey a first fluid in a first direction across one of the first anode and the second cathode. Second flow channels may be interspersed with second ribs along the second side. The second flow channels may be dimensioned to convey a second fluid substantially in the first direction across another one of the first anode and the second cathode. The first flow channels may be established in the respective second ribs. The second flow channels may be established in the respective first ribs. Cross-over ribs may extend between adjacent second ribs to partially interrupt the respective second flow channels. Cross-over channels may be established in the respective cross-over ribs. The cross-over channels may extend across the respective first ribs to interconnect the adjacent first flow channels. The cross-over channels may be dimensioned to convey the first fluid in a second direction transverse to the first direction.

A method of forming a bipolar plate for an electrochemical device may include forming a first flow field in a first side of a metallic plate body. The first flow field may include first flow channels interspersed with first ribs. The first flow channels may extend in a first direction. The first flow field may include cross-over channels that may extend across the respective first ribs to interconnect adjacent first flow channels. The cross-over channels may extend in a second direction transverse to the first direction. The method may include forming a second flow field in a second side of the plate body opposite of the first side. The second flow field may include second flow channels interspersed with second ribs along the second side. The second flow channels may extend substantially in the first direction. The first flow channels may be established in the respective second ribs. The second flow channels may be established in the respective first ribs. The cross-over channels may be established in the respective cross-over ribs.

The present disclosure may include any one or more of the individual features disclosed above and/or below alone or in any combination thereof.

Various features and advantages of at least one disclosed example embodiment will become apparent to those skilled in the art from the following detailed description. The drawing that accompanies the detailed description can be briefly described as follows.

### BRIEF DESCRIPTION OF THE DRAWING

FIG. 1 schematically discloses an electrochemical system including electrochemical devices arranged in a stack.

FIG. 2 discloses the system of FIG. 1 including manifolds.

FIG. 3 discloses another electrochemical system including manifolds.

FIG. 4 discloses a perspective view of a component for an electrochemical device.

FIG. 5 discloses another perspective view of the component of FIG. 4.

FIG. 6 discloses a sectional view of the component taken along line 6-6 of FIG. 4.

FIG. 7 disclose a side view of the component of FIG. 6.

FIG. 8 disclose a sectional view of the component taken along line 8-8 of FIG. 6.

FIG. 9 discloses a method of forming a component for an electrochemical device.

Like reference numbers and designations in the various drawings indicate like elements.

### DETAILED DESCRIPTION

Assemblies for electrochemical devices such as a proton exchange membrane (PEM) electrolyzer or fuel cell may include one or more conductive bipolar plates. Bipolar plates may be relatively costly to fabricate. A single piece stamped part may be utilized to define flow geometry on both sides of the plate. Manifolding may present challenges in a fully stamped design, including arrangements in which both fluids are co-flow or counter-flow (e.g., entering and exiting along the same axis).

The disclosed cross-flow components may include bipolar plates having a fully-stampable configuration of ribs and channels that may establish a cross-flow arrangement. In a cross-flow arrangement, flow on one side of the plate may enter and exit substantially perpendicularly to flow on an opposite side of the plate. The disclosed plates may be incorporated into an electrochemical device such as a PEM electrolyzer and/or fuel cell.

Flow channels and ribs may be established on opposite sides of the plate or other component. On a water (H₂O) side (e.g., anode) of the plate, the ribs may all be full-height to establish flow along the channels. On a hydrogen (H₂) side (e.g., cathode) of the plate, the cross-flow arrangement may include full-height channels and partial-depth (e.g., cross-over) channels that may establish a networked configuration (e.g., cascade). Hydrogen cross flow may be established by the cross-over channels. The networked configuration may establish a cascaded or serpentine hydrogen flow that may be overall perpendicular compared to the water flow on the opposite side of the plate. The cross-over channels may be formed in the plate in a manner that may not substantially block flow along channels on an opposite side of the plate. Hydrogen may be produced all across the cathode surface. The networked configuration of channels may be utilized across the cathode surface. A cross-sectional flow area may be less on the cathode side for conveying hydrogen. On the anode side, water may flow at a relatively higher volume. The cross-flow arrangement may be dimensioned to maintain a minimum pressure across at least the anode side of the plate. The cross-flow arrangements disclosed herein may have improved contact area and flow distribution. The cross-flow arrangement may interface with manifolds that may convey hydrogen and water.

A bipolar plate for an electrochemical device may include a conductive main body extending between a first side and a second side to define a cross-flow arrangement. The cross-flow arrangement may include first flow channels interspersed with first ribs along the first side. The first flow channels may be dimensioned to convey a first fluid in a first direction. Second flow channels may be interspersed with second ribs along the second side. The second flow channels may be dimensioned to convey a second fluid substantially in the first direction. The first flow channels may be established in the respective second ribs. The second flow channels may be established in the respective first ribs. Cross-over ribs may extend across a floor of the respective second flow channels to interconnect adjacent second ribs. Cross-over channels may be established in the respective cross-over ribs. The cross-over channels may extend across the respective first ribs to interconnect the adjacent first flow channels. The cross-over channels may be dimensioned to convey the first fluid in a second direction transverse to the first direction.

In any implementations, the second direction may be substantially perpendicular to the first direction.

In any implementations, the main body may be monolithic.

In any implementations, the main body may have a substantially constant thickness along the cross-flow arrangement.

In any implementations, a floor of each of the cross-over channels may be outward of the floor of each adjacent first flow channel.

In any implementations, ends of the first flow channels may be bounded by a perimeter of the plate.

In any implementations, at least some of the second flow channels may extend from respective ports along a perimeter of the plate.

In any implementations, one or more ports may extend through the main body between the first and second sides. One or more delivery channels may extend along the first side to interconnect the first flow channels and the one or more ports.

In any implementations, one of the first and seconds fluid may be hydrogen. Another one of the first and second fluids may be water.

In any implementations, each first flow channel may define a first width. Each cross-over channel may define a second width. A ratio of the first width to the second width may be between 1:4 and 2:1.

In any implementations, an average thickness of the second ribs may be less than 20 percent of an average width and an average height of the second flow channels, excluding portions of the second flow channels along the cross-over ribs. The average thickness of the second ribs may be less than 20 percent of an average width and an average height of the first flow channels.

An assembly may include a first electrochemical cell including a first proton exchange membrane (PEM) between a first anode and a first cathode. A second electrochemical cell may include a second proton exchange membrane between a second anode and a second cathode. A conductive bipolar plate may be between the first anode and the second cathode. The bipolar plate may extend between first and second sides to define a cross-flow arrangement. The cross-flow arrangement may include first flow channels interspersed with first ribs along the first side. The first flow channels may be dimensioned to convey a first fluid in a first direction across one of the first anode and the second cathode. Second flow channels may be interspersed with second ribs along the second side. The second flow channels may be dimensioned to convey a second fluid substantially in the first direction across another one of the first anode and the second cathode. The first flow channels may be established in the respective second ribs. The second flow channels may be established in the respective first ribs. Cross-over ribs may extend between adjacent second ribs to partially interrupt the respective second flow channels. Cross-over channels may be established in the respective cross-over ribs. The cross-over channels may extend across the respective first ribs to interconnect the adjacent first flow channels. The cross-over channels may be dimensioned to convey the first fluid in a second direction transverse to the first direction.

In any implementations, the first electrochemical cell may be a PEM electrolyzer.

In any implementations, the first flow channels may be fluidly coupled to a first set of manifolds. The second flow channels may be fluidly coupled to a second set of manifolds.

In any implementations, the second direction may be substantially perpendicular to the first direction.

A method of forming a bipolar plate for an electrochemical device may include forming a first flow field in a first side of a metallic plate body. The first flow field may include first flow channels interspersed with first ribs. The first flow channels may extend in a first direction. The first flow field may include cross-over channels that may extend across the respective first ribs to interconnect adjacent first flow channels. The cross-over channels may extend in a second direction transverse to the first direction. The method may include forming a second flow field in a second side of the plate body opposite of the first side. The second flow field may include second flow channels interspersed with second ribs along the second side. The second flow channels may extend substantially in the first direction. The first flow channels may be established in the respective second ribs. The second flow channels may be established in the respective first ribs. The cross-over channels may be established in the respective cross-over ribs.

In any implementations, the steps of forming the first flow field and the second flow field may include stamping the plate body.

In any implementations, the method may include forming the plate body from a foil sheet that may have a substantially planar geometry prior to the steps of forming the first flow field and the second flow field.

In any implementations, the step of forming the first flow field may occur such that a floor of each of the cross-over channels may be raised from a floor of each adjacent first flow channel.

In any implementations, the method may include arranging the first flow field along a cathode of the electrochemical device. The method may include arranging the second flow field along an anode of the electrochemical device.

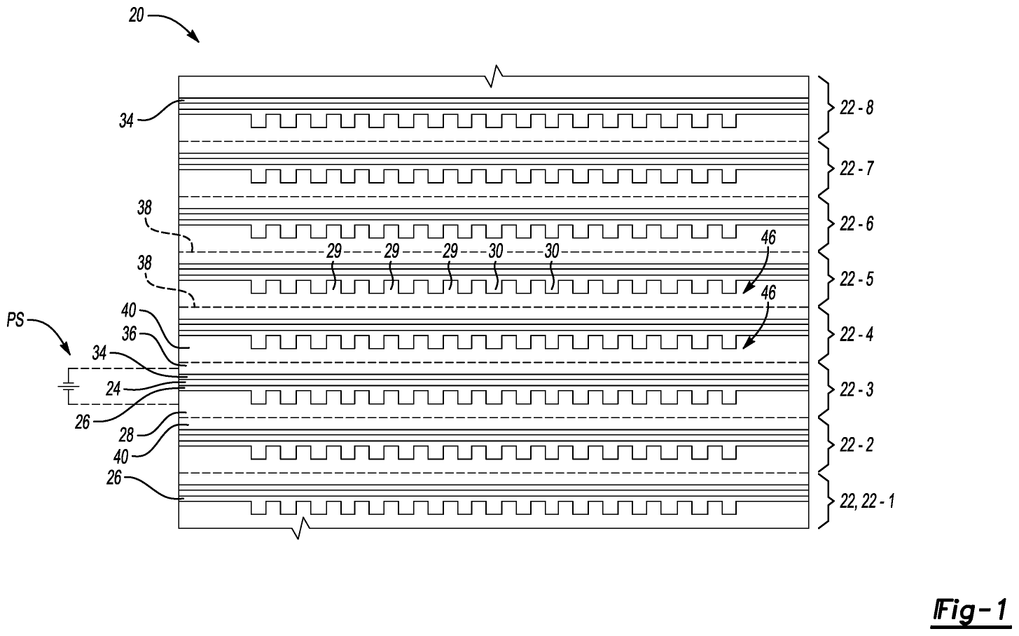

FIG. 1 schematically illustrates an electrochemical system 20. In implementations, the electrochemical system 20 may be an electrolyzer, such as a PEM electrolyzer. Other systems and systems may benefit from the teachings disclosed herein, such as fuel cells.

A plurality of cells 22 may be arranged in a stack. In the implementation of FIG. 1, the system 20 may include at least eight cells (indicated at 22-1 to 22-8). Although a total of eight cells are disclosed, it should be understood that fewer or more than eight cells may be utilized, such as only one cell. The illustrated stack may be considered a sub-stack that may be incorporated in multiple sub-stacks of a larger stack. Each of the cells 22 may include a membrane 24, such as a solid polymer electrolyte (SPE).

A cathode 26 may be situated on one side of the membrane 24. A first (e.g., cathode) flow field 28 adjacent to the cathode 26 may include a plurality of ribs 29 and channels 30. The channels 30 may establish flow passages for collecting hydrogen (H₂) generated by the electrochemical reaction and carrying the hydrogen away from the cell 22. In implementations, water (H2O) may be utilized to sweep hydrogen away from the cell 22. The flow passages of the cathode flow field 28 may be arranged into or out of the page in the illustration. The cathode 26 may include a catalyst adjacent to the membrane 24 and a gas diffusion layer (GDL) adjacent to the cathode flow field 28.

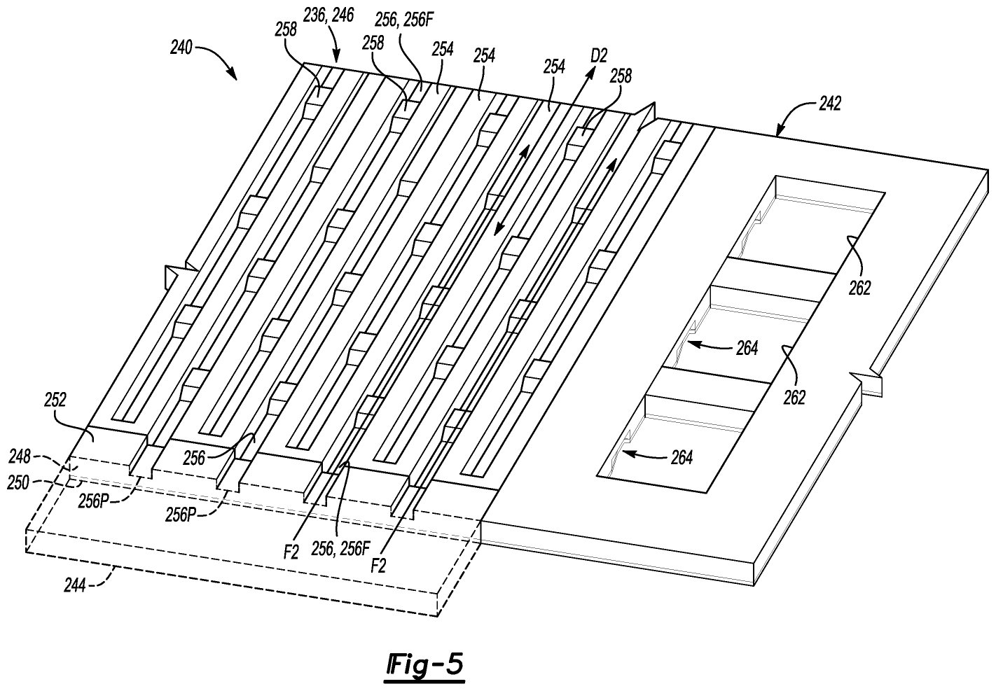

An anode 34 may be situated on an opposite side of the membrane 24 from the cathode 26. The membrane 24 may be situated between the anode 34 and cathode 26. A second (e.g., anode) flow field 36 may include flow channels (see, e.g., FIG. 5) that may supply reactant, such as water, to the anode 34. The flow passages may carry oxygen (O₂) generated from the electrochemical reaction and/or remaining water away from the cell 22. In FIG. 1, the flow channels of the anode flow field 36 may be parallel to the page and may be oriented from one side of the cell 22 to the other side. The anode flow field 36 may include a plurality of ribs and channels (see, e.g., FIG. 5). The ribs and channels of the anode flow field 36 may be perpendicularly oriented relative to the ribs 29 and channels 30 of the cathode flow field 28. The anode 34 may include a catalyst adjacent to the membrane 24 and a gas diffusion layer (GDL) adjacent to the anode flow field 36.

The individual cells 22 may be separated by a separator 38 as schematically shown by the broken lines. In implementations, the cathode flow field 28 and anode flow field 36 of adjacent cells 22 may be established by a single, bipolar plate 40 that may also serve as the separator 38 between the adjacent cells 22. The bipolar plates 40 may be coupled to a (e.g., direct current) power source PS for inducing a current across the cell 22.

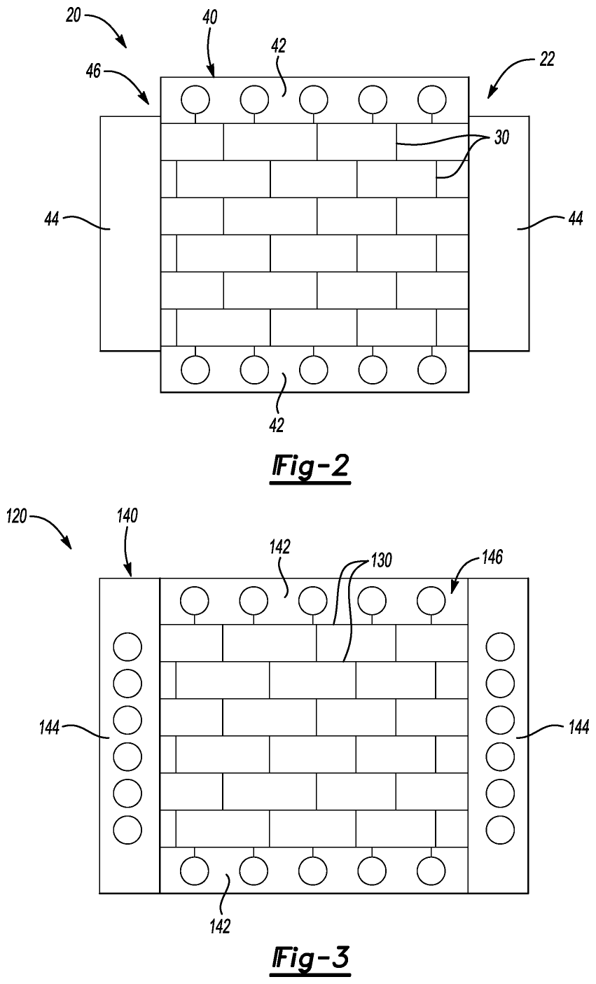

The channels 30 of the cathode flow field 28 and/or the channels of the anode flow field 36 may be dimensioned to communicate flow with one or more manifolds. In the implementation of FIG. 2, the cell 22 may incorporate or otherwise interface with a first set of manifolds 42 and/or a second set of manifolds 44. The manifolds 42 may be internal manifolds established in the plate 40. The manifolds 44 may be external manifolds secured to the cell 22. The bipolar plate 40 may interface with the manifolds 44. The manifolds 42, 44 may be configured to communicate with two or more of the cells 22 of the system 20.

In the implementation of FIG. 3, cell 122 may incorporate a first set of manifolds 142 and a second set of manifolds 144. In this disclosure, like reference numerals designate like elements where appropriate and reference numerals with the addition of one-hundred or multiples thereof designate modified elements that are understood to incorporate the same features and benefits of the corresponding original elements. The manifolds 142, 144 may be internal manifolds. A bipolar plate 140 may incorporate the manifolds 142, 144. The manifolds 142, 144 may communicate with two or more of the cells 122 of the system 120.

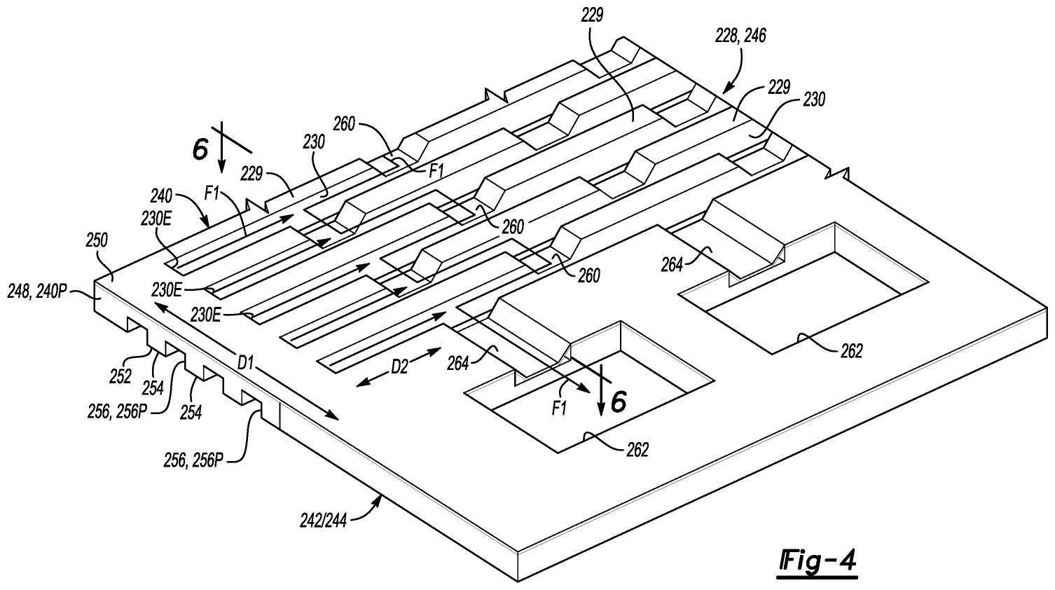

Referring to FIGS. 4-5, with continuing reference to FIGS. 1-2, a component 240 for an electrochemical device is disclosed. The component 240 may be a bipolar plate and/or separator for an electrochemical device, such as a PEM electrolyzer. The electrochemical device may be any of the electrochemical devices disclosed herein, such as an electrolyzer or fuel cell. The bipolar plate 240 may be arranged adjacent to fluid streams, such as a fluid stream of the cathode and/or anode 26, 28 (FIG. 1). The bipolar plate 240 may be electrically conductive and may be established by various metallic materials, such as titanium or stainless steel. The plate 240 may have various geometries, such as a generally planar geometry.

The plate 240 may establish a first flow field 228 (e.g., FIG. 4) and a second flow field 236 (e.g., FIG. 5). The flow fields 228, 236 may be configured to convey flow between a respective set of manifolds 242, 244 (one of each shown in FIG. 5, see also FIGS. 2-3). The plate 240 may be dimensioned to establish a cross-flow arrangement 246. In implementations, a first direction D1 of flow across the first flow field 228 may be substantially perpendicular or otherwise transverse to a second direction D2 of flow across the second flow field 236.

The plate 240 may be incorporated into an assembly including a first electrochemical cell and a second electrochemical cell, such as adjacent cells 22 (FIG. 1). In the implementation of FIG. 1, the first electrochemical cell 22 may include a first membrane 24 between a first anode 34 and a first cathode 28. The membrane 24 may be a proton exchange membrane (PEM). The second electrochemical cell 22 may include a second membrane 24 between a second anode 34 and a second cathode 28. The plate 40 may be arranged between the first anode 34 and the second cathode 28 to define a cross-flow arrangement 46. In implementations, the cross-flow arrangement 46/146 may be configured to convey flow between respective sets of manifolds 42/142, 44/144 (FIGS. 2-3).

The plate 240 may include a conductive main body 248 extending between a first side 250 and a second side 252 to define the cross-flow arrangement 246. In implementations, the main body 248 may be monolithic. The main body 248 may have a substantially constant thickness along the cross-flow arrangement 246. In implementations, the plate 240 may lack any additional flow paths in a thickness of the main body 248 within a perimeter of the cross-flow arrangement 246. The cross-flow arrangement 246 may be dimensioned to convey a first fluid F1 and a second fluid F2 on opposite sides of the plate 240. One of the first and seconds fluids F1, F2 may be hydrogen (H₂). Another one of the first and second fluids F1, F2 may be water (H₂O).

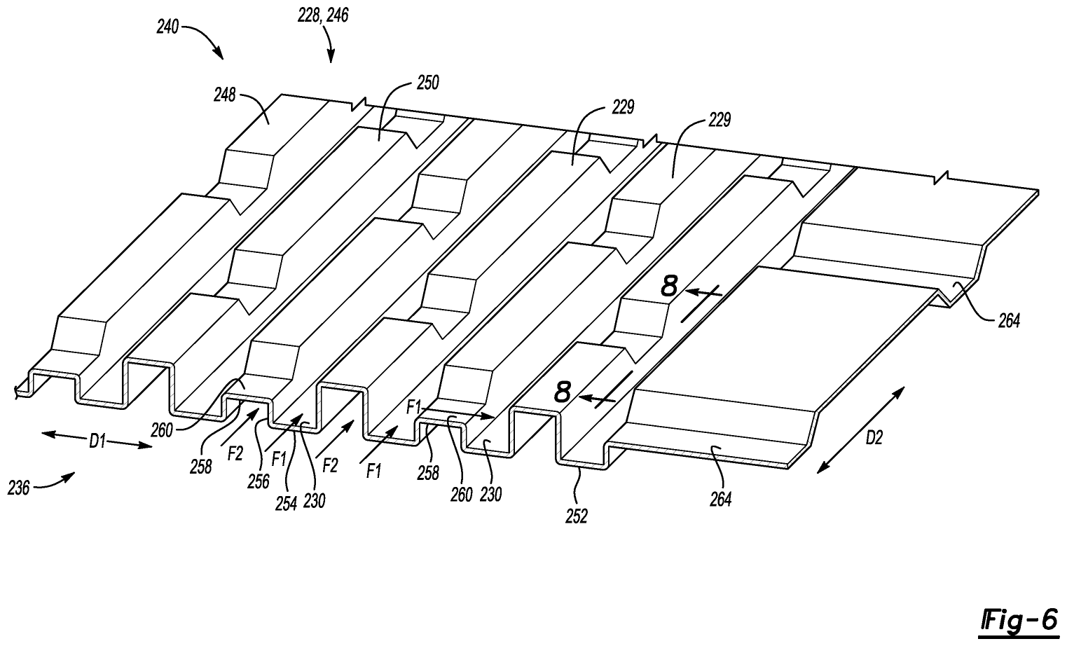

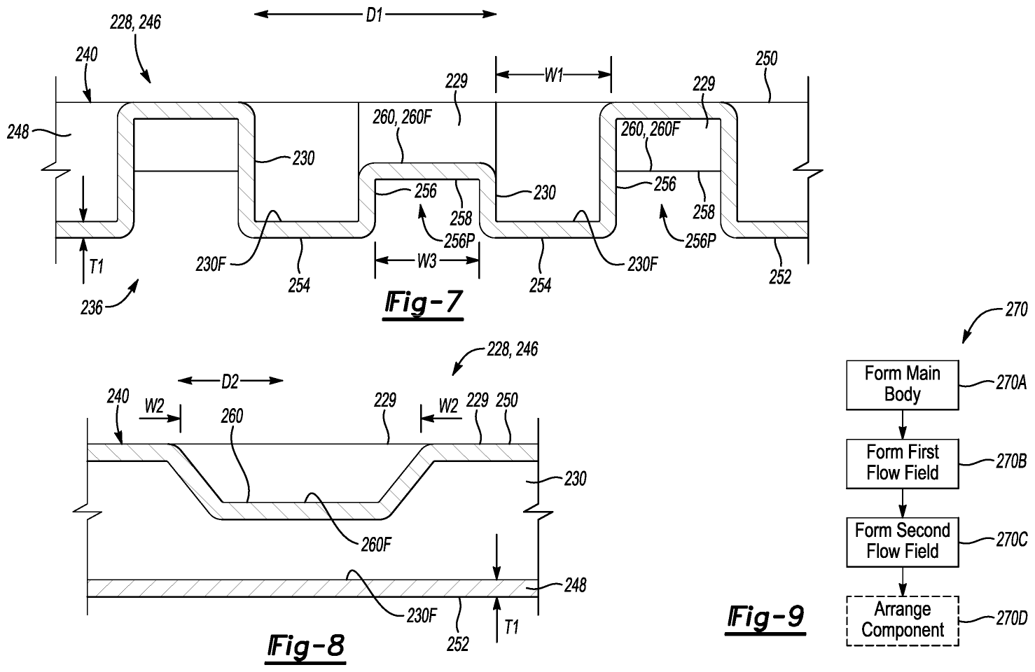

Various techniques may be utilized to establish the cross-flow arrangement 246. The plate 240 may include undulations that may establish channels interspersed with ribs (see, e.g., FIGS. 6-7). The channels may be dimensioned to convey fluid across the respective sides 250, 252 of the plate 240. The channels may establish the first and second flow fields 228, 236.

The first flow field 228 may be dimensioned convey the first fluid F1 in the first direction D1 and/or the second direction D2. In implementations, the first fluid F1 may include hydrogen (H₂). The plate 240 may include a plurality of first ribs 229 interspersed with a plurality of first flow channels 230 along the first side 250 of the main body 248 (FIG. 4). In implementations, the first flow channels 230 may be dimensioned to convey the first fluid F1 in the second direction D2 across the plate 240. Ends 230E of the first flow channels 230 may be bounded by a perimeter 240P of the plate 240 (FIG. 4).

The second flow field 236 may be dimensioned convey the second fluid F2 substantially in the second direction D2. In implementations, the second fluid F2 may include water (H₂O). The plate 240 may include a plurality of second ribs 254 interspersed with a plurality of second flow channels 256 along the second side 252 of the main body 248 (FIG. 5). In implementations, the second flow channels 256 may be dimensioned to convey the second fluid F2 substantially in the second direction D2. For the purposes of this disclosure, the terms “approximately” and “substantially” mean ±10% of the stated value or relationship unless otherwise indicated. In implementations, the first flow channels 230 may be dimensioned to convey the first fluid F1 in the second direction D2 across the cathodes 28 (or anodes 34). The second flow channels 256 may be dimensioned to convey the second fluid F2 substantially in the first direction D1 across the anodes 34 (or cathodes 28). The first flow channels 230 may be fluidly coupled to the first set of manifolds 242. The second flow channels 256 may be fluidly coupled to the second set of manifolds 244. At least some of the second flow channels 256 may extend from respective ports 256P along the perimeter 240P of the plate 240.

In the implementation of FIG. 7, the rows of first channels 230 may be substantially aligned with the rows of second ribs 254 with respect to the first direction D1. The rows of second flow channels 256 may be substantially aligned with the rows of first ribs 229 with respect to the first direction D1. The channels 230, 256 may be offset from each other relative to the first direction D1.

The plate 240 may include a plurality of cross-over ribs (e.g., bumps) 258 along the second side 252 (FIG. 5). The cross-over ribs 258 may be dimensioned to extend across a floor 256F of the respective second flow channels 256 to interconnect adjacent second ribs 254. The cross-over ribs 258 may be dimensioned to extend between adjacent second ribs 254 to partially interrupt the respective second flow channels 256 (see, e.g., FIG. 5).

The plate 240 may include a plurality of cross-over channels 260 for interconnecting adjacent first flow channels 230 (FIG. 4). The cross-over channels 260 may be dimensioned to extend across the respective first ribs 229 to interconnect the adjacent first flow channels 230. The cross-over channels 260 may be dimensioned to convey the first fluid F1 in the first direction D1 across the plate 240. The first flow channels 230 and the cross-over channels 260 may cooperate to establish a networked configuration (e.g., cascade). The cross-over channels 260 may be established in the respective cross-over ribs 258. Sets of cross-over channels 260 may be substantially aligned in the first direction D1 to establish one or more rows. The rows may be offset from each other in the second direction D2. The cross-over channels 260 may be dimensioned such that a floor 260F of each of the cross-over channels 260 may be outward of the floor 230F of each adjacent first flow channel 230 (see, e.g., FIG. 7).

One or more ports 262 may extend through the main body 248 between the first and second sides 250, 252. One or more delivery channels 264 may extend along the first side 250 to interconnect the first flow channels 230 and the ports 262.

Referring to FIGS. 6-7, with continuing reference to FIGS. 4-5, the first flow channels 230 may be established in the respective second ribs 254. The second flow channels 256 may be established in the respective first ribs 229. Utilizing the techniques disclosed here, a relatively greater portion of the plate 240 may establish flow channels 230, 256 for conveying the first and second fluids F1, F2 across the sides 250, 252 of the plate 240.

Referring to FIGS. 7-8, with continuing reference to FIGS. 4-6, various techniques may be utilized to dimension the cross-flow arrangement 246, including the first flow channels 230, second flow channels 256 and cross-over channels 260. The first flow channels 230 and/or the second flow channels 256 may be equal to or less than about 1.0 mm deep and/or equal to or less than about 1.0 mm wide. The cross-over channels 260 may be shallower than the first flow channels 239. The cross-over channels 260 may be dimensioned to establish a minimum flow and/or a minimum pressure. In implementations, the cross-over channels 260 may be between about 0.25 mm and about 2.0 mm wide, inclusive.

Each first flow channel 230 may define a first width W1 (FIG. 7). Each cross-over channel 260 may define a second width W2 (FIG. 8). In implementations, a ratio W1:W2 of the first width W1 to the second width W2 may be between 1:4 and 2:1. Each second flow channel 256 may define a third width W3 (FIG. 7). The first width W1 and the second width W2 may be the same or may differ from each other.

The main body 248 may define a first thickness T1 across the cross-flow arrangement 246. An average of the thickness T1 of the second ribs 254 may be less than 20 percent of an average width and/or an average height of the second flow channels 256, excluding portions of the second flow channels 256 along the cross-over ribs 258. An average of the thickness T1 of the second ribs 254 may be less than 20 percent of an average width and/or an average height of the first flow channels 230.

Referring to FIG. 9, a method of forming a component for an electrochemical device in a flowchart 270 is disclosed according to an implementation. Method 270 may be utilized to form various components of an electrochemical device, including any of the electrochemical devices disclosed herein and/or components thereof such as an electrolyzer or fuel cell. In implementations, the component may be a bipolar plate and/or a separator, such as the bipolar plate 240. Fewer or additional steps than are recited below could be performed within the scope of this disclosure, and the recited order of steps is not intended to limit this disclosure. Reference is made to the bipolar plate 240 of FIGS. 4-8.

At step 270A, a metallic main (e.g., plate) body 248 may be formed. The main body 248 may be monolithic or may include two or more separate components joined together. In implementations, the main body 248 may be formed from a foil sheet having a substantially planar geometry. The main body 248 may incorporate any of the materials disclosed herein.

At step 270B, a first flow field 228 may be formed in a first side 250 of the main body 248. The first flow field 228 may include first flow channels 230 interspersed with first ribs 229. The first flow channels 230 may extend in a second direction D2. The first flow field 228 may include cross-over channels 260 that may extend across the respective first ribs 229 to interconnect adjacent first flow channels 230. The cross-over channels 260 may extend in a first direction D1, which may be substantially perpendicular or otherwise transverse to the second direction D2. Forming the first flow field 228 may occur such that a floor 260F of each of the cross-over channels 260 may be raised from a floor 230F of each adjacent first flow channel 230.

At step 270B, a second flow field 236 may be formed in a second side 252 of the main body 248. Steps 270B and 270C may occur concurrently or in sequence. Forming the main body 248 at step 270A may occur prior to the forming the first flow field 228 at step 270B and/or forming the second flow field 236 at step 270C.

The second flow field 236 may include second flow channels 256 interspersed with second ribs 254 along the second side 252. The second flow channels 256 may extend substantially in the second direction D2. Steps 270B, 270C may occur such that the first flow channels 230 and second flow channels 256 may be substantially parallel to each other. Steps 270B, 270C may occur such that the first ribs 229 and the second ribs 254 may be substantially parallel to each other. The first flow channels 230 may be established in the respective second ribs 254. The second flow channels 256 may be established in the respective first ribs 229. The cross-over channels 260 may be established in the respective cross-over ribs 258.

Various techniques may be utilized to form the first and second flow fields 228, 236, such as one or more casting, machining, or additive manufacturing operations. In implementations, forming the first flow field 228 at step 270B and/or forming the second flow field 236 at step 270C may include stamping or otherwise permanently deforming the main body 248. Step 270B may include stamping the first side 250 of the main body 248 to establish the first channels 230 and respective second ribs 254. Step 270B may include stamping the first side 250 of the main body 248 to establish the cross-over channels 260 and respective cross-over ribs 258. Step 270C may include stamping the second side 252 of the main body 248 to establish the second flow channels 256 and the respective first ribs 229.

At step 270D, the component 240 may be arranged relative to one or more other components of an electrochemical device, such as one or more of the cells 22 (FIG. 1). The component 240 may be arranged utilizing any of the techniques disclosed herein. Step 270D may include arranging the first flow field 228 along a cathode 26 (or anode 34) of the electrochemical device. Step 270D may include arranging the second flow field 236 along an anode 34 (or cathode 26) of the electrochemical device.

The disclosed techniques may be utilized to establish a component having a cross-flow arrangement that may be incorporated into an electrochemical device. The component may be a conductive bipolar plate that may be stamped or otherwise formed in a manner that may facilitate cross-flow on opposite sides of the plate. The plate may be formed in a manner that may reduce manufacturing complexity and cost.

The preceding description is illustrative rather than limiting in nature. Variations and modifications to the disclosed examples may become apparent to those skilled in the art that do not necessarily depart from the essence of this invention.

What is claimed:

1. A bipolar plate for an electrochemical device comprising:
a conductive main body extending between a first side and a second side to define a cross-flow arrangement;
wherein the cross-flow arrangement comprises:
first flow channels interspersed with first ribs along the first side, the first flow channels dimensioned to convey a first fluid in a first direction;
second flow channels interspersed with second ribs along the second side, the second flow channels dimensioned to convey a second fluid substantially in the first direction;
wherein the first flow channels are established in the respective second ribs;
wherein the second flow channels are established in the respective first ribs;
cross-over ribs that extend across a floor of the respective second flow channels to interconnect adjacent second ribs; and
wherein cross-over channels are established in the respective cross-over ribs, the cross-over channels extend across the respective first ribs to interconnect the adjacent first flow channels, and the cross-over channels are dimensioned to convey the first fluid in a second direction transverse to the first direction.

2. The bipolar plate as recited in claim 1, wherein the second direction is substantially perpendicular to the first direction.

3. The bipolar plate as recited in claim 1, wherein the main body is monolithic.

4. The bipolar plate as recited in claim 3, wherein the main body has a substantially constant thickness along the cross-flow arrangement.

5. The bipolar plate as recited in claim 1, wherein a floor of each of the cross-over channels is outward of the floor of each adjacent first flow channel.

6. The bipolar plate as recited in claim 1, wherein ends of the first flow channels are bounded by a perimeter of the plate.

7. The bipolar plate as recited in claim 1, wherein at least some of the second flow channels extend from respective ports along a perimeter of the plate.

8. The bipolar plate as recited in claim 1, wherein one or more ports extend through the main body between the first and second sides, one or more delivery channels extend along the first side to interconnect the first flow channels and the one or more ports.

9. The bipolar plate as recited in claim 1, wherein one of the first and seconds fluid is hydrogen, and another one of the first and second fluids is water.

10. The bipolar plate as recited in claim 1, wherein each first flow channel defines a first width, each cross-over channel defines a second width, and a ratio of the first width to the second width is between 1:4 and 2:1.

11. The bipolar plate as recited in claim 1, wherein:
an average thickness of the second ribs is less than 20 percent of an average width and an average height of the second flow channels, excluding portions of the second flow channels along the cross-over ribs; and
the average thickness of the second ribs is less than 20 percent of an average width and an average height of the first flow channels.

12. An assembly comprising:
a first electrochemical cell including a first proton exchange membrane (PEM) between a first anode and a first cathode;
a second electrochemical cell including a second proton exchange membrane between a second anode and a second cathode; and
a conductive bipolar plate between the first anode and the second cathode, the bipolar plate extending between first and second sides to define a cross-flow arrangement comprising:
first flow channels interspersed with first ribs along the first side, the first flow channels dimensioned to convey a first fluid in a first direction across one of the first anode and the second cathode;
second flow channels interspersed with second ribs along the second side, the second flow channels dimensioned to convey a second fluid substantially in the first direction across another one of the first anode and the second cathode;
wherein the first flow channels are established in the respective second ribs;
wherein the second flow channels are established in the respective first ribs;
cross-over ribs extending between adjacent second ribs to partially interrupt the respective second flow channels; and
wherein cross-over channels are established in the respective cross-over ribs, and the cross-over channels extend across the respective first ribs to interconnect the adjacent first flow channels, the cross-over channels dimensioned to convey the first fluid in a second direction transverse to the first direction.

13. The assembly as recited in claim 12, wherein the first electrochemical cell is a PEM electrolyzer.

14. The assembly as recited in claim 12, wherein the first flow channels are fluidly coupled to a first set of manifolds, and the second flow channels are fluidly coupled to a second set of manifolds.

15. The assembly as recited in claim 12, wherein the second direction is substantially perpendicular to the first direction.

16. A method of forming a bipolar plate for an electrochemical device comprising:
forming a first flow field in a first side of a metallic plate body, the first flow field including first flow channels interspersed with first ribs, the first flow channels extending in a first direction, and the first flow field including cross-over channels that extend across the respective first ribs to interconnect adjacent first flow channels, and the cross-over channels extend in a second direction transverse to the first direction;
forming a second flow field in a second side of the plate body opposite of the first side, the second flow field including second flow channels interspersed with second ribs along the second side, and the second flow channels extending substantially in the first direction; and
wherein the first flow channels are established in the respective second ribs, the second flow channels are established in the respective first ribs, and the cross-over channels are established in the respective cross-over ribs.

17. The method as recited in claim 16, wherein the steps of forming the first flow field and the second flow field include stamping the plate body.

18. The method as recited in claim 16, further comprising forming the plate body from a foil sheet having a substantially planar geometry prior to the steps of forming the first flow field and the second flow field.

19. The method as recited in claim 16, wherein the step of forming the first flow field occurs such that a floor of each of the cross-over channels is raised from a floor of each adjacent first flow channel.

20. The method as recited in claim 16, further comprising:
arranging the first flow field along a cathode of the electrochemical device; and
arranging the second flow field along an anode of the electrochemical device.
